(19) United States
(12) Patent Application Publication
(10) Pub. No.: US 2018/0043775 A1
(43) Pub. Date: Feb. 15, 2018

(54) EXTERNAL POWER CONTROL SYSTEM

(71) Applicant: NATHAN FERRIE, STORY CITY, IA (US)

(72) Inventor: NATHAN FERRIE, STORY CITY, IA (US)

(21) Appl. No.: 15/233,979

(22) Filed: Aug. 11, 2016

(51) Int. Cl. B60K 28/00; B60Q 1/26; G05B 15/02

(52) U.S. Cl. CPC B60K 28/00; G05B 15/02; B60Q 1/2696; B60K 2028/003

(57) ABSTRACT

The present invention provides an external power control system. This external power control system enables a user to shut off the power immediately from outside position. The external power control system allows the user to quickly shut off the power in the case of an emergency. This external power control system comprises a controller which is located outside of the vehicle to give easy access to the user from the exterior position.

### FIELD OF THE INVENTION

The present invention relates to an external power control system that provides safety and security for users of heavy machinery by automatically cutting off the power supply.

### BACKGROUND OF THE INVENTION

On a worksite or farm where heavy equipment is in use the job poses some risk of personal injury to the workers working on or around the machinery in the field. This machinery is very heavy and often contains attachments or auxiliary tools that have dangerous moving parts as well. The machinery is usually operated from a driver's seat and contains only one place to start and stop the vehicle, which is within the driver's controls.

In the event of an emergency such as a sustained injury by a worker near the equipment, the threat of imminent injury to workers in the vicinity, the failure of the driver to operate the vehicle for any reason, or a threat of damage to property, the only one who is able to disable the vehicle by disrupting the operation of the vehicle motors or power supply is the one in the driver's seat or cabin.

Moreover, the driver's seat or cabin is often in an elevated position on heavy machinery or farm equipment and cannot easily be reached from the ground, and provides an obstacle to those surrounding the machine who would wish to stop the operation of the machine in the event of an emergency.

Therefore, there remains a need to overcome above mentioned problems and our invention resolve this entire problem.

### SUMMARY OF THE INVENTION

In order to solve the above mentioned problems; the present invention provides an external power control system. The external power control system enables someone to shut off the power for vehicles like bulldozers, tractors, or any farming equipment. The external power control system allows the user to quickly shut off power to the vehicle in the case of an emergency. The external power control system comprises a controller, coupled to at least one power source of the vehicle and the controller is further coupled to an engine of the vehicle, wherein the controller is located externally on the vehicle enabling actuation of at least one power source of the vehicle by at least one user. Once the controller of the external power control system is pressed, the engine of the vehicle would shut down immediately which would further lead to stopping of the heavy vehicles, leading to prevention of any accidents or any mishap. The controller of the external power control system is provided with a cover member and at least one light source, wherein the cover member is made up of a material which is easy to break and provides security to the controller from the external surroundings like heat, pressure, water and thereby, protects the normal functioning of the controller. Moreover, the at least one light source provided to the controller enables easy visibility of the controller in the dark or in the night.

Moreover, in a situation when the vehicle meets with an emergency including crashing of the electric circuit system supporting the mechanism and working of the vehicle due to which the vehicle ran out of control, then the vehicle enabled with the external power control system, comes into play, wherein the controller is coupled to at least one source of the vehicle and further coupled to an engine of the vehicle is kept safe within a cover member securing normal functioning of the controller. Therefore, in an emergency situation the user present outside the vehicle is enabled to access the controller from outside, wherein in order to access the controller user first has to break the cover member. After the user breaks the cover member they are enabled to press the controller. Once the controller of the external power control system has been pressed, the power of the vehicle would shut down immediately which would further lead to prevention of any accidents or any mishaps. The controller herein, is also provided with the light source that enables easy visibility of the controller to the user outside the vehicle and makes the process easy for the user.

### BRIEF DESCRIPTION OF THE DRAWINGS

The following drawing illustrates the exemplary embodiment;

FIG. 1 illustrates the schematic view of the given invention according to an embodiment of the invention.

### DETAIL DESCRIPTION OF THE INVENTION

Reference will now be made in detail to the exemplary embodiment(s) of the invention, examples of which are illustrated in the accompanying drawing. Whenever possible, the same reference numerals will be used throughout the drawings to refer to the same or like parts.

References to “one embodiment,” “at least one embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications, patents and patent computer implemented methods mentioned herein are incorporated herein in their entirety.

The present invention provides an external power control system. The external power control system provides the ability to shut off the power for the vehicles like bulldozers, tractors, or any farming equipment. The external power control system allows the user to quickly shut off power to the vehicle in the case of an emergency. The external power control system comprises a controller, coupled to at least one power source of the vehicle and the controller is further coupled to an engine of the vehicle, wherein the controller is located externally on the vehicle. Once the controller of the external power control system has been pressed, the engine of the vehicle would shut down immediately, leading to prevention of any accidents or any mishap. The controller of the external power control system is provided with a cover member and at least one light source, wherein the cover member is made up of a material which is easy to break and provides security to the controller from the external surroundings like heat, pressure, water and thereby, and protects the normal functioning of the controller. Moreover, the light source provided to the controller enables easy visibility of the controller in the dark or in the night.

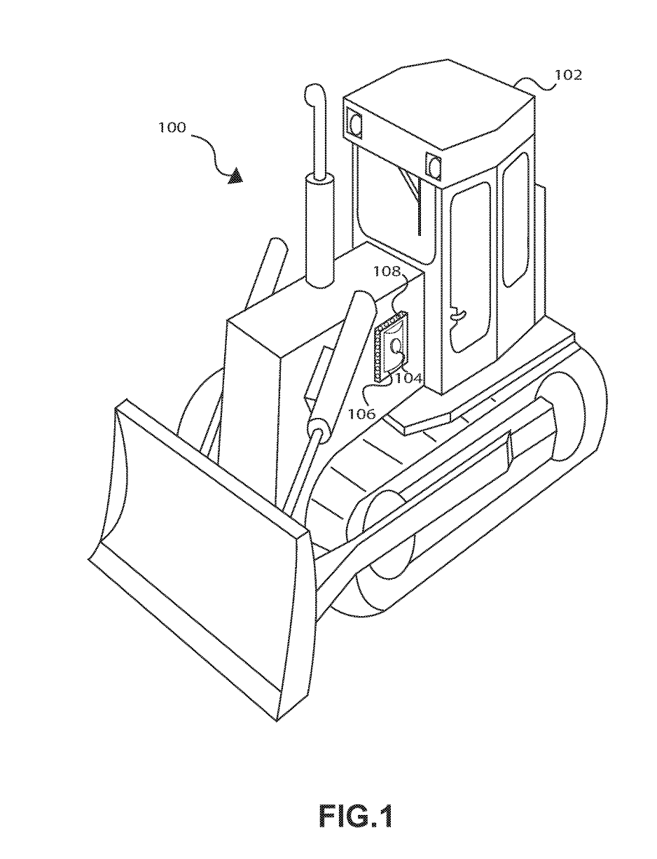

FIG. 1 illustrates the schematic view of the given invention of the external power control system. The external power control system [100], comprises a controller [102], a vehicle [104], at least one power source [106], a cover member [108] and a light source [110]. Herein, the controller [102] is a device or a switch used for making and breaking the connection in an electric circuit provided for the vehicle [104]. The at least one power source [106] provided to at least one external power control system [102] is either a renewable or a non-renewable source of energy for the vehicle [104], enabling the vehicle [104] in the working conditions, wherein the renewable source of electricity provided by the at least one power source [106] of the vehicle [104] is derived from the naturally occurring energy sources on earth which includes either one of water, sun, biomass, wind, geothermal energy or the combination thereof and the non-renewable source of energy for the power source [106] of the vehicle [104] includes at least one of a collector system, a battery, a generator to convert fuel to electricity or the combination thereof. Moreover, the at least one external power control system [100] is also provided with a cover member [108], wherein the cover member [108] is enabled preventing any external disturbance that is moisture, heat or pressure by any external surroundings and further protect the normal functioning of the at least one external power control system [100]. This cover member [108] is made of a material with is easy to break and make, which enables the at least one user to easily access the controller [102] at the time of any emergency for the vehicle [104]. This cover member [108] is made up of a material which includes either one of glass, plastic, fiber or the combination thereof. The at least one external power control system [100] further comprises a light source [110] coupled with the controller [102] enabling easy visibility of the light source [110] in the night. This light source [110] includes either one of LED, reflector or the combination thereof. The controller [102] provided herein, to at least one external power control system [100] is coupled to at least one power source [106], of the vehicle [104]. The controller [102] of the external power control system [100] is further coupled to an engine of the vehicle [104]. The controller [102] is located externally on the vehicle [104] enabling actuation of at least one power source [106] of the vehicle [104] by at least one user, wherein the at least one user is present outside the vehicle [104]. The external power control system [100] requires a moderate design effort to integrate the different parts of the external power control system [100] into a working state for each separate type of vehicle [104].

In the preferred embodiment of the given invention of the external power control system [100]. A situation when the vehicle [104] meets with an emergency including crashing of the electric circuit system supporting the mechanism and working of the vehicle [104] and thereby run out of control, then the vehicle [104] enabled with at least one external power control system [100], wherein the external power control system [100] comprises a controller [102], an vehicle [104], at least one power source [106], a cover member [108] and a light source [110], comes to play, wherein the controller [102] is coupled to at least one power source of the vehicle and further coupled to an engine of the vehicle is kept safe within a cover member [108] made up of any material which easy to break and provide full security to the controller [102] thereby, securing normal functioning of the controller [102]. Therefore, in a situation of the emergency the user present outside the vehicle [104] is enabled to access the controller [102] from outside, wherein in order to access the controller [102] the user first has to break the cover member. After the user breaks the cover member [110], The user is enabled to press the controller [102], once the controller [102] of the external power control system [100] has been pressed, the engine of the heavy vehicle [104] would shut down immediately which would further lead to stopping of the heavy vehicle [100] leading to prevention of any accidents or any mishaps of the vehicle [100]. The controller [102] herein is provided with the at least one light source [110] that enables easy visibility of the controller [102] to at least one user outside the vehicle [104] and makes the further process easy for the at least one user.

While the invention has been described in detail with specific reference to preferred embodiments thereof, it is understood that variations and modifications thereof may be made without departing from the true spirit and scope of the invention.

What is claimed is:

1. At least one external power control system for an electric vehicle comprising of: a controller, coupled to at least one power source of the vehicle and further coupled to an engine of the vehicle, wherein the controller is located externally on the vehicle enabling actuation of at least one power source of the vehicle by at least one user, wherein the user is present outside the vehicle.

2. The system in claim 1; wherein the controller is removably coupled to the vehicle.

3. The system in claim 1; wherein the controller is integrally coupled to the vehicle.

4. The system in claim 1; wherein the controller is provided with a cover member to protect the controller from external factors.

5. The system in claim 1; wherein the controller is coupled to at least one light source enabling visibility of the controller during night and at least one light source includes either one of LED, reflector or the combination thereof.
